(19) United States
(12) Patent Application Publication
(10) Pub. No.: US 2006/0036701 A1
(43) Pub. Date: Feb. 16, 2006

(54) Messaging system having message filtering and access control

(76) Inventors: Andrew Frederick Bulfer, Mountain Lakes, NJ (US); Charles C. Schwing, Aberdeen, NJ (US)

Correspondence Address: AT&T Corp.;Room 2A-207, One AT&T Way, Bedminster, NJ, 07921, US

(21) Appl. No.: 11/254,831

(22) Filed: Oct. 20, 2005

Related U.S. Application Data
(62) Division of application No. 10/033,266, filed on Dec. 28, 2001.
(60) Provisional application No. 60/331,803, filed on Nov. 20, 2001.

(51) Int. Cl. G06F 15/16

(52) U.S. Cl. 709/206

(57) ABSTRACT

An electronic message system provides message filtering for allowing a supervisory user, e.g., a parent, to control the flow of messages to other users, such as a child. E-mail messages and/or instant messages from already approved senders are allowed to pass directly to the child's account. Messages from unapproved senders are forwarded to the parent's account for deletion or approval to forward to the child and/or prospective sender approval.

### CROSS REFERENCE TO RELATED APPLICATIONS

This application claims the benefit of U.S. Provisional Patent Application No. 60/331,803 filed on Nov. 20, 2001, which is incorporated herein by reference.

### STATEMENT REGARDING FEDERALLY SPONSORED RESEARCH

Not Applicable.

### FIELD OF THE INVENTION

The present invention relates generally to communication systems and, more particularly, to systems that send and receive electronic messages.

### BACKGROUND OF THE INVENTION

As is well known in the art, the Internet provides a means for users to send and receive E-mail messages and so-called instant messages to other Internet users. Individuals use the Internet to contact friends and family members. Businesses use the Internet to conduct transactions without the need for voice communication, which can greatly enhance efficiency and reduce costs. Such electronic messages are typically welcomed by the message recipient.

However, in certain instances it is desirable to block incoming electronic messages that are unwanted or inappropriate for various users. For example, many parents desire to prevent their children from receiving unwanted E-mail messages, i.e., spam, particularly those having adult content. Some service providers, such as AT&T WorldNet, provide a so-called E-mail Parental Control (EPC) feature for filtering messages to prevent certain messages from reaching children. In AT&T WorldNet, for example, EPC is implemented as an “Accept-List” specified by the parent containing E-mail addresses from which E-mail will be accepted by the child's mailbox. E-mail from any other sender is summarily deleted when it arrives with no indication to the sender, recipient, or parent, that the message was deleted.

Thus, desired messages may be deleted along with unacceptable messages. This can occur because a particular sender was mistakenly left off the list, because a sender e-mail address has changed, etc. In addition, it is relatively difficult for the parent to manage and administer the list because the deleted messages are never seen.

It would, therefore, be desirable to provide an electronic system that overcomes the aforesaid and other disadvantages.

### SUMMARY OF THE INVENTION

The present invention provides an E-mail system that enables a supervisory user, such as a parent, to control the flow of incoming messages to other users, such as children. With this arrangement, a parent can allow a child to access the child's E-mail account with the knowledge that only messages from selected senders will reach the child. While the invention is primarily shown and described in conjunction with Internet E-mail accounts for parents and children, it is understood that the invention is applicable to message systems in general, such as wireless messaging and voice mail systems, in which it is desired for a supervisory user to filter incoming messages for a supervised user.

In one aspect of the invention, E-mail messages to a first E-mail client, which can correspond to a child's E-mail address, are filtered to determine the identity of the message sender. Messages from senders contained in a control fist are forwarded to the first E-mail client's inbox. Messages from unapproved senders, i.e., not in the control list, are forwarded to a second E-mail account, such as a parent's E-mail account, for processing. In one embodiment, a screen display enables the parent to approve messages and/or senders. The processed messages are forwarded to the first E-mail client so that approved messages can be accessed by the child and approved senders can be added to the control list.

In a further aspect of the invention, instant messages to a supervised client are filtered to determine whether the sender is contained in an approved sender list. Upon determining that the instant message is from an unapproved sender, approval for the message and/or sender is requested from a supervisory client. The supervisory client can approve sending of the instant message to the supervised client and/or add the sender to an approved sender or control list associated with the supervised client.

### BRIEF DESCRIPTION OF THE DRAWINGS

The invention will be more fully understood from the following detailed description taken in conjunction with the accompanying drawings, in which:

FIG. 1 is a schematic depiction of an E-mail system having message filtering and review in accordance with the present invention;

FIG. 2 is a schematic depiction showing further details of the system of FIG. 1;

FIG. 3 is a pictorial representation of an exemplary screen display that can used by the system of FIG. 1; and

FIG. 4 is a flow diagram showing an exemplary sequence of steps for implementing an E-mail system having message filtering and review processing in accordance with the present invention.

FIG. 5 is a schematic depiction of a system having instant messaging functionality that includes message filtering in accordance with the present invention; and

FIG. 6 is a schematic depiction of a further system having instant messaging functionality that includes message filtering in accordance with the present invention.

### DETAILED DESCRIPTION OF THE INVENTION

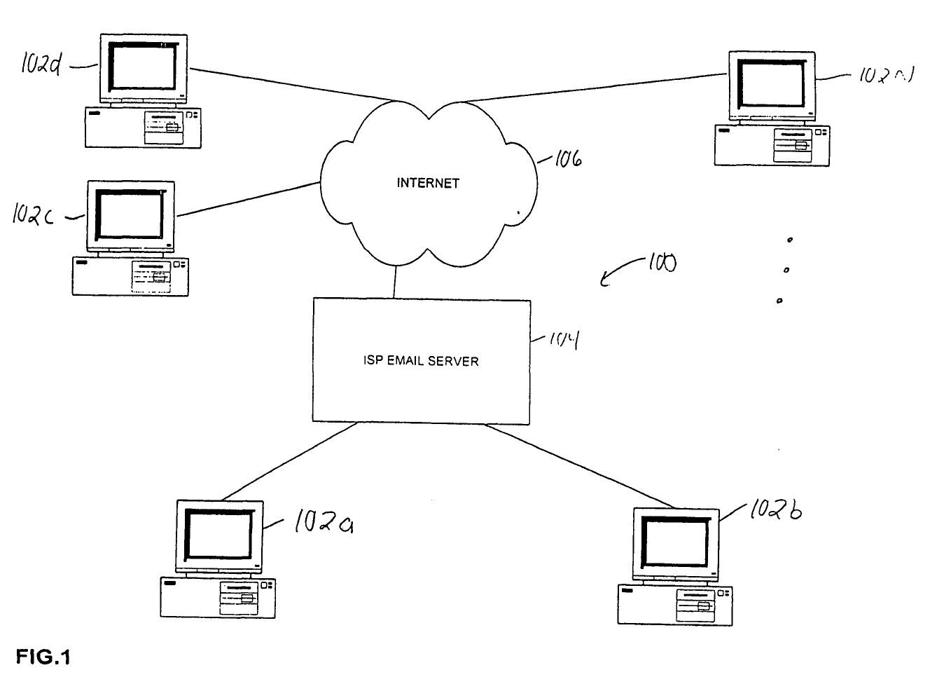

FIG. 1 shows an exemplary E-mail system 100 having message filtering in accordance with the present invention. The E-mail system 100 serves a plurality of clients 102a-N including a supervisory, e.g., parent, client 102b, and supervised, e.g., child, client 102a. While parent and child are used here to facilitate an understanding of the invention, it is understood that a wide variety of a supervisory/supervised relationships are possible. In general, the supervisory client 102b can control the flow of messages to the supervised client 102a, as described below.

The system 100 includes an email server 104, which can be operated by an Internet Service Provider (ISP), such as AT&T Worldnet. The server 104 is coupled to the Internet 106 so as to enable E-mail communication between the various clients 102 in a manner well known in the art. In an exemplary embodiment, the parent client 102b and the child client 102a are connected to the E-mail server 104.

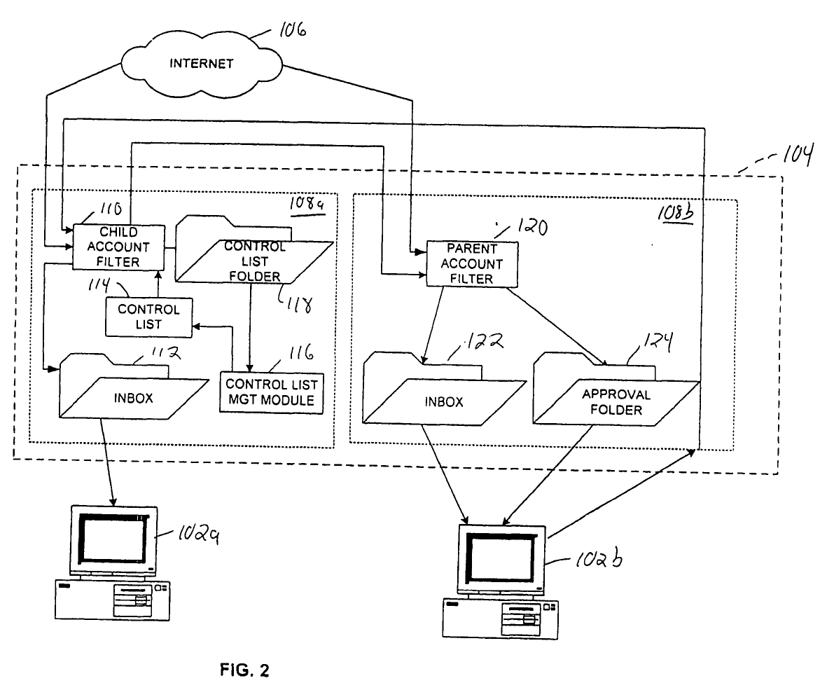

FIG. 2 shows further details of the E-mail server 104 of FIG 1, in which like reference number indicate like elements. The server 104 includes a child account 108a associated with the child client 102a and a parent account 108b associated with the parent client 102b. The child account includes a filter 110 for filtering messages intended for receipt by the child client 102a. In general, the filter 110 passes messages from approved senders directly to the child account inbox 112 for access by the child client. Messages from non-approved senders are forwarded to the parent account 108b for processing as described in detail below.

An (E-mail Parental Control) EPC list 114 is coupled to the filter 110 for storing a list of approved senders. An EPC management module 116 works in conjunction with an EPC list management folder 118 and the EPC list 114 to manage message filtering for the child account 108a under the direction of the parent account 108b. More particularly, the management module 116 adds senders in the control list folder 118 to the control list 114.

The parent account 108b includes a filter 120 for receiving messages submitted for approval by the child account 108a as well as messages addressed to the parent client 102b. A parent inbox 122 stores messages for the parent client 102b and an EPC or approval inbox 124 stores messages to be reviewed for approval. Approved messages are forwarded to the child account filter 110 for message processing and sender addition, as described below.

In operation, an E-mail message addressed to the child client 102a is received by the child account filter 110 on the server 104. The filter 110 determines whether the sender, e.g., the E-mail account in the message “from” field, is contained in the EPC list 114. That is, the filter 110 determines whether the message is from an approved sender. Messages from approved senders are placed in the child account inbox 112. It is understood that the “reply to” field can be examined in addition to the sender field.

If the message is not from an approved sender, the filter 110 places an indication thereof, e.g., a so-called X-line for Sieve-based filters, in the message header, for example. The X-line indicates that the message was filtered and forwarded to the parent 108b account for processing. The message is then received by the parent account filter 120. Messages having an X-line indicating message filtering and forwarding are placed in the EPC folder 124. The parent client 108b can then access and process messages in the EPC folder 124.

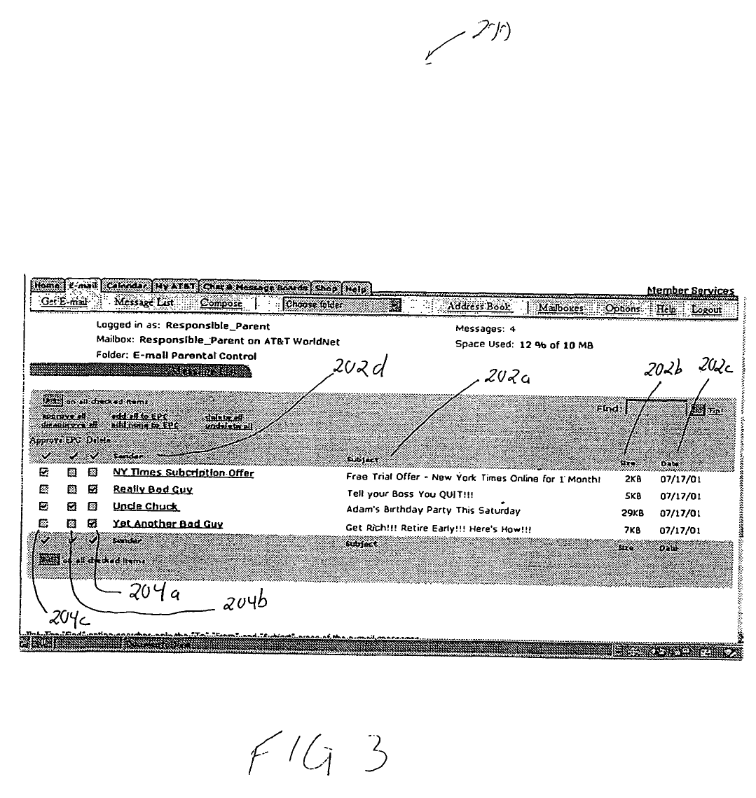

FIG. 3 shows an exemplary screen display 200 for showing messages in the EPC folder. The screen 200 has conventional features including field displays for subject 202a, size 202b, date 202c, and sender 202d. The screen further includes a series of checkboxes 204, for example, for enabling processing of the EPC message. In an exemplary embodiment, the EPC screen display 200 include a delete message box 204a, an EPC box 204b, and an approve box 204c. By activating the delete box 204a, e.g., checking the box, the message will be deleted. Checking the approve box 204c results in the message being forwarded to the child client inbox 112 (FIG. 2), and checking the EPC box 204b results in the sender becoming an approved sender contained in the EPC list 114 (FIG. 2). In one particular embodiment, the parent client inserts an X-line into the message header for Sieve filter processing-indicating that the message and/or sender was approved.

Referring again to FIG. 2, a message processed and approved by the parent is sent to the child account and handled by the filter 110. The filter 110 examines the messages and identifies any X-lines that are present. In the case where the message contains an X-line indicating that the message was approved, the message is sent to the child account inbox 112. In the case where the X-line indicates the sender should be added to the approved sender list, the message is also sent to the child account inbox 112. In addition, the sender identity is forwarded to the EPC management list folder 118. The EPC list management module 116 then processes the information in the list folder 118 and adds the sender to the EPC or control list 114. Subsequent messages from the newly approved sender can then pass directly to the child account inbox 112.

In one particular embodiment, the message contains no indication that a parent has reviewed the sender and/or message, e.g., the X-line is stripped off by the child account filter 110. That is, the sender and the child have no indication that the sender identity and/or message content was reviewed by the parent. In an alternative embodiment, such an indication can be provided. For example, an approved sender and/or child may receive an indication of approved message status. It is understood that a variety of notifications can be sent to the parties.

In an exemplary embodiment, the parent can remove senders in the child's EPC list by sending an E-mail, for example. It will be readily apparent that modifications to the EPC list can be achieved using a variety of mechanisms well known to one of ordinary skill in the art.

It is understood that a variety of message filters can be used to filter incoming messages. In one particular embodiment, a Sieve filter is used to examine the recipient field of incoming messages. As is known in the art, Sieve is a language used for E-mail filtering that is an Internet Standard identified as RFC3028.

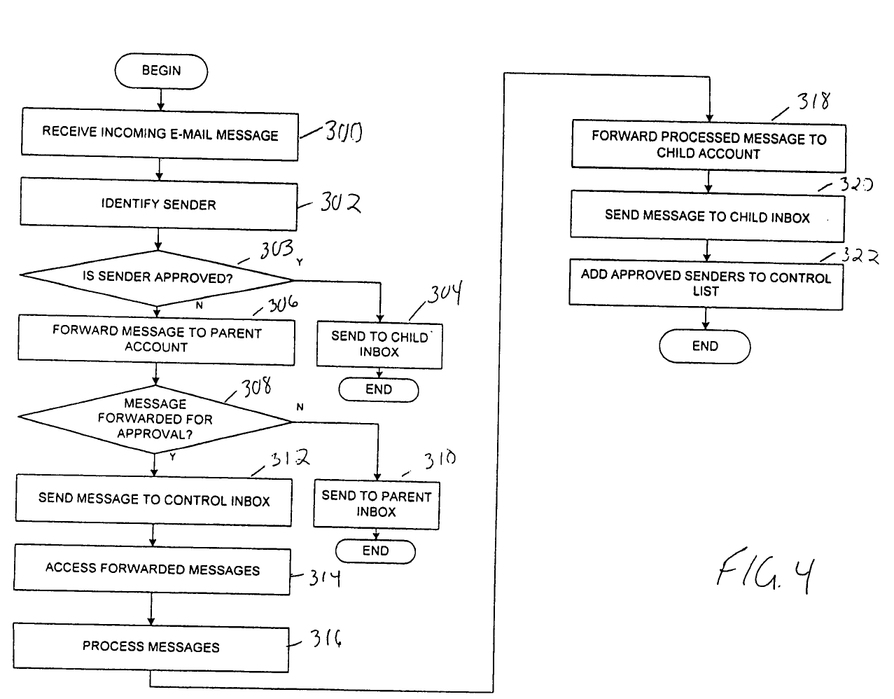

FIG. 4 shows an exemplary sequence of steps for implementing E-mail filtering and review in accordance with the present invention. In step 300, the child account receives an incoming message via the Internet from a sender. In step 302, a child account filter examines the identify of the sender and in step 303 determines whether the sender is contained in the control list of approved senders for the child. If so, the message is forwarded to the child account inbox in step 304. If not, in step 306 the message is forwarded to the parent account.

In step 308, the parent account filter determines whether the incoming message is a message addressed to the parent client or whether the message has been forwarded for approval. In step 310, messages addressed to the parent client are forwarded to the parent account inbox. Messages forwarded for approval are sent to the EPC folder in step 312.

In step 314, the parent accesses the forwarded messages via a display screen, such as that shown in FIG. 3. In step 316, the parent processes the forwarded messages by selecting, e.g., checking a box, the messages for deletion, message approval, and/or sender approval. Approved messages (message and/or sender) are forwarded to the child account in step 318. In step 320, the child account filter handles the message by sending approved messages and sender approved messages to the inbox. And in step 322, newly approved senders are added to the control list.

In a further aspect of the invention, a system provides message filtering of instant messages in a manner that is similar to E-mail message filtering described above. In general, a supervisory client, e.g., a parent, controls a list of approved senders that can transmit instant messages to a supervised client, e.g., a child.

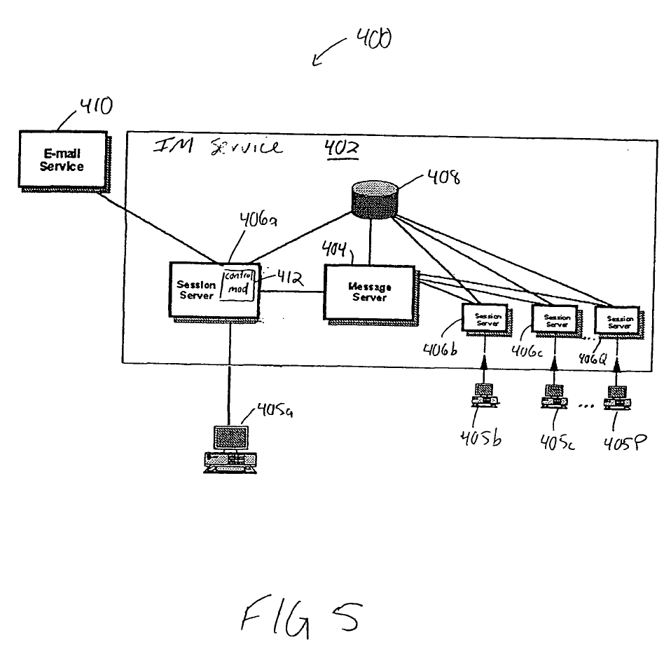

FIG. 5 shows an exemplary system 400 including instant message filtering in accordance with the present invention. The system 400 provides message filtering capability integrated into an instant messaging service 402, which can be provided by an Internet Service Provider (ISP), such as AT&T WorldNet. The service 402 includes a message server 404 that routes messages from various clients 405a-P that have logged on to respective session servers 406a-Q. An IM database 408 maintains state and location information for the system IM users. An E-mail service 410 can be used to request and receive permission from the parent in a manner similar to that described above in conjunction with FIG. 2.

The session servers 406 each include a control module 412 for preventing instant messages from being delivered to a supervised first client 405a if the message sender is not contained in the control list for the first client. In one particular embodiment, the control list for each client 404 is contained in the IM database 408. The control list for a supervised client, such as a child, is controlled by a supervisory client, e.g., a parent, as described below.

In operation, the clients 405 log on to the IM service 402 via a session server 406. Upon client login, the IM database 408 is updated to reflect the online status of the logged in clients 405. Each client can then be informed, such as by a display screen, of the online status of other previously identified clients. Messages can be exchanged between on-line clients using the message server 404 which can transmit such messages via the session servers 406. In such a message exchange, the IM database 408 is used to determine the recipient's location and message routing.

Each supervised client, e.g., first client 405a, has an associated control list, which can be similar to the control list 114 of FIG. 2, containing senders that have been approved by a supervisory client. An instant message from a sender to the supervised first client 405a is examined by the control module 412 to determine whether that sender is contained in the control list, which can be contained in the IM database 408. If the sender is on the list, the message is forwarded to the first client 405a as usual. If the sender is not in the list, then the message is prevented from reaching the first client 405a.

The control module 412 then sends the instant message or other message indication to the supervisory client, e.g., parent. In one particular embodiment, the control module 412 sends an E-mail message to the parent account via the E-mail service 410 requesting approval for the message and/or sender. The parent can then approve the message and/or sender after which the first client's control list is updated to contain the sender. The sender can then exchange instant messages with the first client 405a.

In another aspect of the invention, the ability of other users to view the supervised first client's on-line state can be controlled via the IM database 408. The IM database can be arranged to report the on-line state of the first client only to those other clients contained in the control lists and similarly, report the on-line state of only those other clients contained in the control list to the first client.

It is understood that an ISP can readily determine the child/parent accounts by accessing the ISP's network access servers (NAS) to associate the originating IP address with the user's ID. The user's ID can then be looked up in the ISP account management system to determine the parent account associated with the child's account.

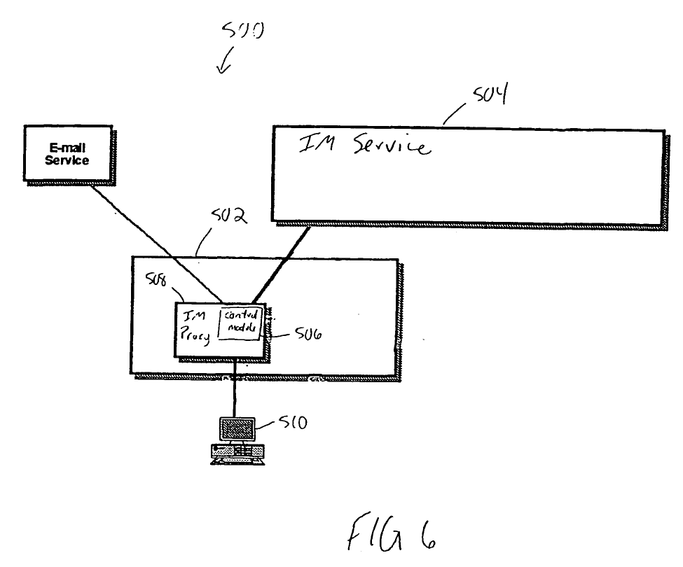

FIG. 6 shows an alternative system 500 having message control for an ISP 502 that is external to an IM service 504. The system 500 includes a message control module 506 as part of an EM proxy 508 within the ISP 502. The IM proxy 508 detects the port number of the external TM service and relays data between the client 510 and the IM service 504. The control module 506 within the IM proxy 508 filters messages from unapproved senders and prohibits changes to control lists without supervisory instructions, as described above.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method for filtering electronic messages, comprising:
examining a first electronic message from a sender to a supervised client, said supervised client supervised by a supervisory client;
determining whether the sender has been approved by said supervisory client to send electronic messages to the supervised client, said supervisory client having a different address than said supervised client; and
preventing receipt of the first electronic message by the supervised client if the sender has not been approved by the supervisory client.

2. The method according to claim 1, further including sending a second electronic message to the supervisory client requesting approval for receipt of the message by the supervised client.

3. The method according to claim 1, further including sending a second electronic message to the supervisory client requesting approval for the sender to send messages to the supervised client.

4. The method according to claim 3, wherein the second electronic message is a forwarded version of the first electronic message.

5. The method according to claim 1, further including providing a screen display enabling the supervisory client to approve the first electronic message and/or the sender.

6. The method according to claim 1, further including storing a control list containing a list of approved senders for the supervised client.

7. The method according to claim 1, wherein the first electronic message corresponds to an E-mail message.

8. The method according to claim 1, wherein the first electronic message corresponds to an instant message.

9. A method for filtering E-mail messages, comprising:
examining a first E-mail message sent by a sender and addressed to a first E-mail client;
determining whether the sender has been approved to send messages to the first E-mail client by a second E-mail client, said first E-mail client having a different address than said second E-mail client;
processing the first E-mail message by the second E-mail client to enable message approval and/or sender approval; and
forwarding the first E-mail message to the first E-mail client upon approval of the first E-mail message.

10. The method according to claim 9, further including processing the first E-mail message to enable reading of subsequent E-mail messages sent from the sender.

11. The method according to claim 9, further including filtering E-mail messages with a Sieve filter.

12. The method according to claim 9, further including managing a control list of approved senders for the first E-mail client.

13. The method according to claim 9, further including processing the first E-mail message by appending information to the processed message indicative of message and/or sender approval.

14. The method according to claim 13, further including appending one or more X-lines to a header of the first E-mail message.

15. A method for approving E-mail messages, comprising:
identifying a sender of an E-mail message to a first client;
determining whether the E-mail message is from a sender contained in a control list;
forwarding the E-mail message to a second client, said second client having a different address than said first client, if the sender is not in the control list;
enabling a second client to review the E-mail message;
enabling the second client to approve the E-mail message and/or add the sender to the control list; and
forwarding the E-mail message to the first client.

16. The method according to claim 15, further including filtering the E-mail message with a Sieve filter.

17. The method according to claim 16, further including attaching one or more X-lines to the E-mail message indicative of message and/or sender approval.

18. The method according to claim 15, further including adding the sender after approval to the control list.

19. The method according to claim 15, further including providing a screen display enabling the second client to approve the E-mail message and/or the sender.

20. An E-mail filtering system, comprising:
a first account associated with a first user having a first filter coupled to a control list for determining whether incoming E-mail messages are from senders contained in the control list; and
a second account having a different address than said first account, said second account associated with a second user having a second filter for determining whether incoming messages were forwarded from the first account, wherein forwarded messages and/or senders approved by the second user are forwarded to the first account for message access by the first user and for addition of the approved senders to the control list.

21. The system according to claim 20, wherein the first filter includes a Sieve filter.

22. The system according to claim 20, wherein the second account further includes a control folder for holding messages forward from the first account for approval.

23-32. (canceled)
